(19) United States
(12) Patent Application Publication
(10) Pub. No.: US 2012/0075621 A1
(43) Pub. Date: Mar. 29, 2012

(54) OPTICAL FIBER CONNECTOR

(75) Inventor: SONG-YUEH GAU, HSINCHU COUNTY 302 (TW)

(73) Assignee: LIVERAGE TECHNOLOGY INC., HSINCHU COUNTY 302 (TW)

(21) Appl. No.: 12/944,911

(22) Filed: Nov. 12, 2010

(30) Foreign Application Priority Data
Sep. 28, 2010 (TW) 099218690

(51) Int. Cl. G01N 21/00; G02B 6/42; G02B 6/00; G02B 6/36

(52) U.S. Cl. 356/73.1; 385/53; 362/551; 362/553

(57) ABSTRACT

The present invention relates to an optical fiber connector, which comprises a tube member, an optical-fiber module, a positioning member, and a position-limiting member. The back end of the tube member puts around a light-source module or an inspection module. The optical-fiber module is disposed at the front end of the tube member. The positioning member is disposed in the optical-fiber module. The position-limiting member puts around the positioning member and is disposed in the optical-fiber module. Thereby, when a user measures or inspects the optical fiber, the position-limiting member is used for limiting the assembly position of the optical fiber. Besides, the positioning member is used for aligning the optical fiber with the inspection module or the light-source module accurately. Thereby, the alignment of optical fibers can be performed in convenience.

### FIELD OF THE INVENTION

The present invention relates generally to a connector, and particularly to an optical fiber connector.

### BACKGROUND OF THE INVENTION

With technological development, the communication technology changes with each passing day. By means of the construction of communication facilities such as telephone and network, the distance between people is closer and closer. The transmission between communication facilities is achieved in wireless or wired methods. However, wireless transmission tends to be influenced by weather and terrain conditions, engendering interference problems in communication, which is difficult to be controlled effectively. Thereby, wired transmission is still the most effective and stable method for signal transmission at the present day. Wired transmission uses cables as the signal transmission lines for electronic or optical signals. In particular, optical signal transmission is the fastest method, which uses optical fibers as the transmission media.

Using optical fibers as the communication media has many advantages, such as long-distance communication and low cost. In comparison with traditional transmission systems using copper cables, the distance between two repeaters of an optical fiber communication is increased to a few tens of kilometers and hence decreasing substantially the number of repeaters. Thereby, the cost of the communication is reduced. In addition, optical fibers have an ultra-wide communication bandwidth, normally above one to two GHz. The bandwidth of a general coaxial cable is around 330 to 550 MHz. By comparison, optical fibers have an extremely high signal-carrying capacity. Besides, the material of general optical fibers is quartz glass, which is corrosion-free, fire-resistant, water-tolerant, and has long lifetime. They also have superior flexibility, adaptation, and protective coating and anti-tension materials, which save operational costs of optical-fiber transmission. Moreover, the medium of optical fibers is made of quartz glass, which is an excellent insulator and free from interference of electromagnetic waves. Thereby, optical fibers are suitable to be applied to areas vulnerable to lightning strokes or high electric fields, and thus enhancing substantially the communication fidelity. Furthermore, communication using optical fibers has high confidentiality. Optical signals will not radiate from optical fibers, and hence suitable for military, bank networking, and computer networking applications.

Because of the advantages of an optical fiber system described above, many countries regard the prospects of optical communication are brightening, and have invested a great deal of financial and human resources fro research and development. With the coming of information age, communication networks with large capacity, low loss, and superior reliability are indispensable, and the optical-fiber communication system is the best choice. Thereby, it is expected that in the near future, most copper cables will be replaced by optical fibers. Since the debut of optical fibers, their installation rate is increased rapidly, and they are welcomed by the communication and telecommunication industries.

Optical fibers are very expensive and vulnerable. Hence, they are generally installed in protection pipes or culverts for avoiding artificial destruction. Normally, the diameters of protection pipes or culverts are not large; while general optical fiber inspection or measurement apparatuses according to prior art have relatively larger size and thus inconvenient for carrying. Consequently, when optical fibers fail, engineering personnel cannot use large-sized optical fiber inspection or measurement apparatuses for inspection or measurement. Instead, small-sized optical fiber inspection or measurement apparatuses are used. However, these small-sized optical fiber inspection or measurement apparatuses need connectors to connect with optical fibers. It is uneasy to work in protection pipes or culverts, making the alignment between optical fibers and connectors difficult, and hence affecting the convenience of inspection or measurement.

Accordingly, the present invention provides an optical fiber connector, which can facilitate connection of optical fibers and connectors. Thereby, the alignment of optical fibers can be performed in convenience, and thus enhancing convenience of optical fiber inspection or measurement.

### SUMMARY

An objective of the present invention is to provide an optical fiber connector, which limits the assembly position of an optical fiber by means of a position-limiting member, and aligns the optical fiber with an inspection module or a light-source module by means of a positioning member. Thereby, the alignment of optical fibers can be performed in convenience, and thus enhancing convenience of optical fiber inspection or measurement.

The optical fiber connector according to the present invention comprises a tube member, an optical-fiber module, a positioning member, and a position-limiting member. The back end of the tube member puts around a light-source module or an inspection module. The optical-fiber module is disposed at the front end of the tube member, and comprises a fixing base and a guiding optical fiber. The fixing base is disposed at the front end of the tube member and connects with the positioning member. The guiding optical fiber is disposed in the fixing base. The positioning member is disposed in the optical-fiber module, and comprises a positing outer tube and a positioning inner tube. The positioning outer tube is disposed in the fixing base and puts around the guiding optical fiber; the positioning inner tube is disposed in the positioning outer tube and opposite to the guiding optical fiber. The position-limiting member puts around the positioning member and is disposed in the optical-fiber module. Thereby, when a user measures or inspects the optical fiber, the position-limiting member is used for limiting the assembly position of the optical fiber. Besides, the positioning member is used for aligning the optical fiber with the inspection module or the light-source module accurately. Thereby, the alignment of optical fibers can be performed in convenience, and thus enhancing convenience of optical fiber inspection or measurement.

### BRIEF DESCRIPTION OF THE DRAWINGS

FIG. 1 shows a structural schematic diagram of an optical fiber connector according to a preferred embodiment of the present invention;

FIG. 2 shows an exploded view of an optical fiber connector according to a preferred embodiment of the present invention;

FIG. 3 shows a structural schematic diagram of a positioning inner tube according to a preferred embodiment of the present invention;

FIG. 4A shows a structural schematic diagram of an optical fiber connector according to another preferred embodiment of the present invention; and

FIG. 4B shows a structural schematic diagram of an optical fiber connector according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

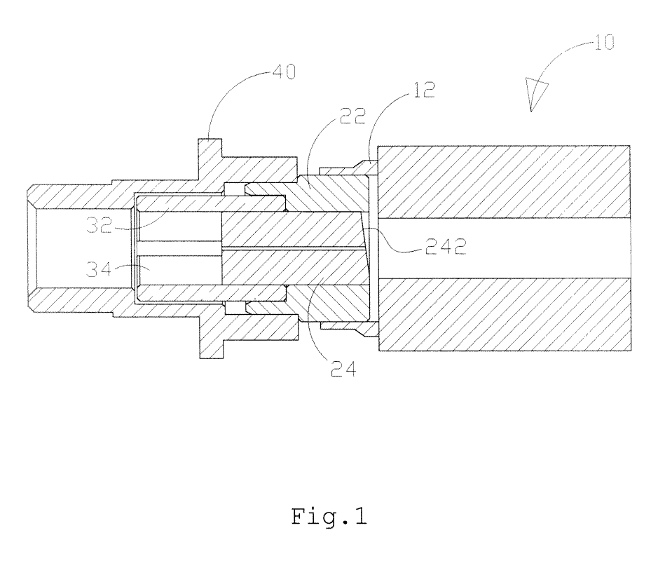

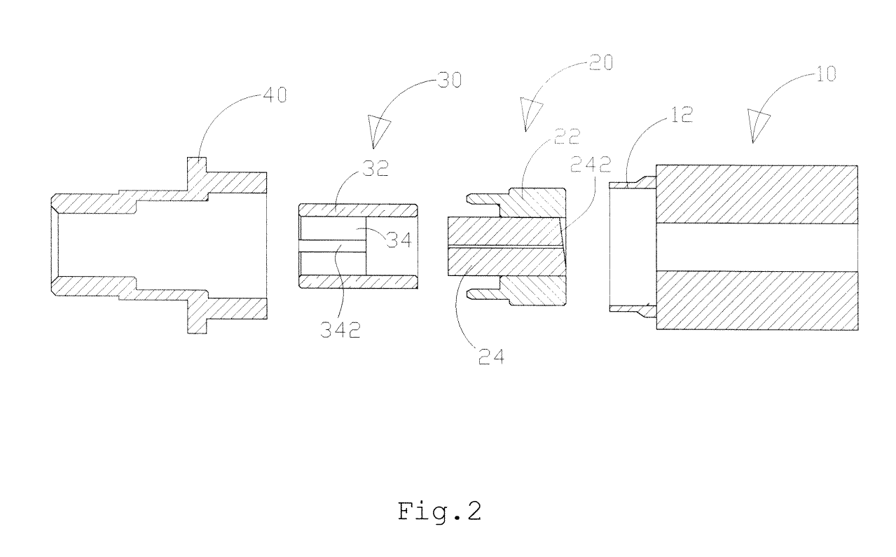

FIG. 1 and FIG. 2 show a structural schematic diagram and an exploded view of an optical fiber connector according to a preferred embodiment of the present invention. As shown in the figure, the optical fiber connector according to the present invention can be applied to disposing a light-source module or an inspection module. The optical fiber connector comprises a tube member 10, an optical-fiber module 20, a positioning member 30, and a position-limiting member 40. The back end of the tube member 10 puts around the light-source module or the inspection module. The optical-fiber module 20 is disposed at the front end of the tube member 10. The positioning member 30 is disposed in the optical-fiber module 20. The position-limiting member 40 puts around the positioning member 30 and is disposed on the optical-fiber module 20.

The optical-fiber module 20 according to the present invention comprises a fixing base 22 and a guiding optical fiber 24 The fixing base 22 is disposed at the front end of the tube member 10 and connects with the positioning member 30. The guiding optical fiber 24 is disposed in the fixing base 22. The guiding optical fiber 24 is fixed at the front end of the tube member 10 by means of the fixing base 22, thereby facilitating measurement or inspection of the optical fiber by the light-source module or the inspection module at the back end of the tube member via the optical-fiber module 20. In addition, when the light-source module or the inspection module is disposed at the back end of the tube member 10, the light-source module or the inspection module will emit light to the guiding optical fiber 24, such that a portion of the light transmits through the guiding optical fiber 24, while the other portion reflects from the broken surface of guiding optical fiber 24. The reflected light superposes the light emitted from the light-source module or the inspection module and produces noise, and hence influencing the inspected or measured value of the optical fiber. Accordingly, an inclined plane 242 is disposed at the guiding optical fiber 24 opposite to the front end of the tube member 10. When the light-source module or the inspection module is assembled to the tube member 10, a portion of the light emitted from the light-source or the inspection module will transmits through the guiding optical fiber 24, while the other portion will reflect from the inclined plane 242. By using the incline plane 242, reflection of the reflected light back to the light-source module or the inspection module can be avoided, and thus enhancing the using convenience of the guiding optical fiber 24 in the connector.

The positioning member 30 according to the present invention comprises a positing outer tube 32 and a positioning inner tube. As shown in FIG. 1 and FIG. 2, the positioning outer tube 32 is disposed in the fixing base 22 and puts around the guiding optical fiber 24; the positioning inner tube 34 is disposed in the positioning outer tube 32 and opposite to the guiding optical fiber 24. Thereby, when connecting the optical fiber connector according to the present invention with an optical fiber, the optical fiber will be inserted into the positioning outer tube 32. Then by further pushing the optical fiber inwards, the optical fiber will be inserted into the positioning inner tube 34. Thereby, the optical fiber can be assembled and opposite to the optical-fiber module 20 with more convenience. Moreover, the position-limiting member 40 according to the present invention puts around the positioning member 30 and is disposed in the optical-fiber module 20. Thereby, while assembling the optical fiber to the connector according to the present invention, the optical fiber will be inserted into the position-limiting member 40 first, facilitating aligning the optical fiber with the positioning member 30, and hence enhancing convenience in alignment. According to the above description, when a user measures or inspects the optical fiber, the position-limiting member 40 according to the present invention is used for limiting the assembly position of the optical fiber. Besides, the positioning member 30 is used for aligning the optical fiber with the inspection module or the light-source module accurately. Thereby, the alignment of optical fibers can be performed in convenience.

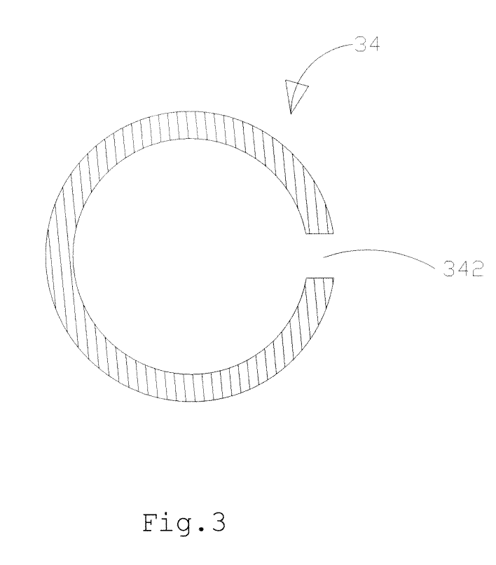

FIG. 3 shows a structural schematic diagram of a positioning inner tube according to a preferred embodiment of the present invention. As shown in the figure, the diameter of the positioning inner tube 34 according to the present invention is identical to that of the optical fiber. Thereby, the optical fiber and the optical-fiber module 20 can position each other. However, this will make the optical fiber difficult to pass through the positioning inner tube 34. For increasing positioning convenience, the positioning inner tube 34 according to the present invention further has an opening 342 at its side. Thereby, the elasticity of the positioning inner tube 34 can be increased. When the optical fiber is inserted into the positioning inner tube 34, the positioning inner tube 34 can be slightly opened and hence facilitating assembly of the optical fiber.

Refer back to FIG. 1 and FIG. 2. In order to enhance assembly convenience of the optical fiber, the present invention further comprises a fixing tube 12 disposed at the front end of the tube member 10 and puts around the optical-fiber module 20. In this way, the optical-fiber module 20 can be assembled to the tube member with more ease.

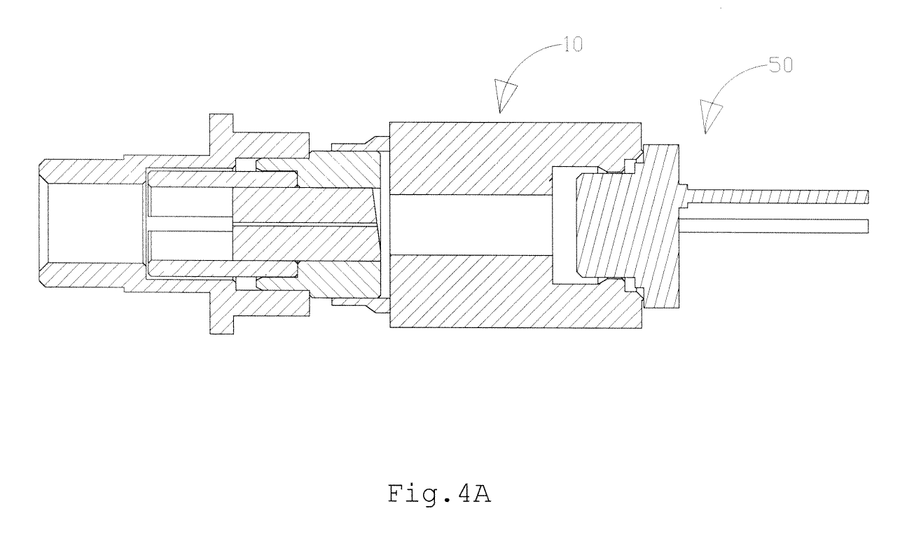

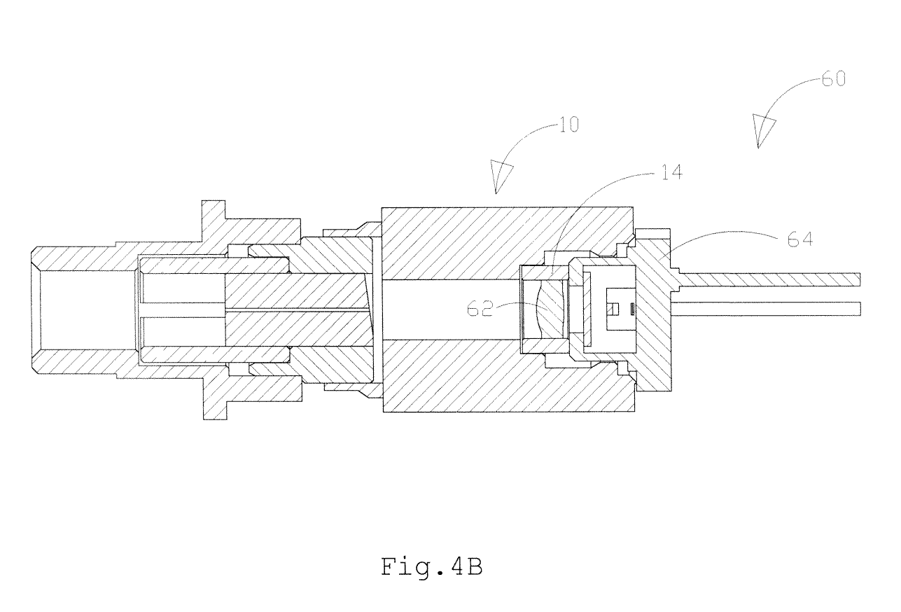

FIG. 4A and FIG. 4B show structural schematic diagrams of optical fiber connectors according to other preferred embodiments of the present invention. As shown in the figures, the optical fiber connector according to the present invention is used for connecting to the light-source module or the inspection module. For convenience, the present invention further comprises an inspection module 50 disposed at the back end of the tube member 10. The inspection module 50 is a photocoupler, as shown in FIG. 4A. By means of the inspection module 50, the optical fiber connector according to the present invention can be connected directly to an inspection circuit (not shown in the figure), such that the present invention can be applied to apparatuses for optical fiber inspection. Alternatively, the present invention further comprises a light-source module 60 disposed at the back end of the tube member 10, as shown in FIG. 4B. By means of the light-source module 60, the optical fiber connector can be connected to a driving circuit (not shown in the figure), and hence enhancing using convenience of the present invention.

Furthermore, in the embodiment of FIG. 4B, the light-source module 60 comprises an optical device 62 and a light source 64. The light source 64 is a laser diode. The optical device 62 is disposed at the back end of the tube member 10; the light source 64 is disposed at the back end of the tube member and opposite to the optical device 62. A fixing part is disposed at the back end of the tube member 10. The optical device 62 is disposed in the fixing part 14. The optical device 62 includes at least a lens. The embodiment in FIG. 4B adopts a lens for example. Multiple lenses can be adopted according to practical requirements.

To sum up, the present invention relates to an optical fiber connector, which comprises a tube member, an optical-fiber module, a positioning member, and a position-limiting member. The back end of the tube member puts around a light-source module or an inspection module. The optical-fiber module is disposed at the front end of the tube member. The positioning member is disposed in the optical-fiber module. The position-limiting member puts around the positioning member and is disposed in the optical-fiber module. Thereby, when a user measures or inspects the optical fiber, the position-limiting member is used for limiting the assembly position of the optical fiber. Besides, the positioning member is used for aligning the optical fiber with the inspection module or the light-source module accurately. Thereby, the alignment of optical fibers can be performed in convenience.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An optical fiber connector, comprising:
a tube member;
an optical-fiber module, disposed at the front end of said tube member, comprising a fixing base and a guiding optical fiber, said fixing base disposed at the front end of said tube member, and said guiding optical fiber disposed in said fixing base;
a positioning member, disposed in said optical-fiber module, connected with said fixing base, comprising a positioning outer tube and a positioning inner tube, said positioning outer tube disposed in said fixing base and putting around said guiding optical fiber, said positioning inner tube disposed in said positioning outer tube and opposite to said guiding optical fiber; and
a position-limiting member, putting around said positioning member, and disposed in said optical-fiber module.

2. The optical fiber connector of claim 1, wherein said guiding optical fiber has an inclined plane opposite to the front end of said tube member.

3. The optical fiber connector of claim 1, wherein said positioning inner tube has an opening at a side.

4. The optical fiber connector of claim 1, and further comprising a fixing tube disposed at the front end of said tube member and putting around said optical-fiber module.

5. The optical fiber connector of claim 1, and further comprising an inspection module disposed at the back end of said tube member.

6. The optical fiber connector of claim 5, wherein said inspection module is a photocoupler.

7. The optical fiber connector of claim 1, and further comprising a light-source module disposed at the back end of said tube member.

8. The optical fiber connector of claim 7, wherein said light-source module comprises:
an optical device, disposed at the back end of said tube member; and
a light source, disposed at the back end of said tube member and opposite to said optical device.

9. The optical fiber connector of claim 8, wherein a fixing part is disposed at the back end of said tube member, and said optical device is disposed in said fixing part.

10. The optical fiber connector of claim 8, wherein said optical device includes at least a lens.

11. The optical fiber connector of claim 8, wherein said light source is a laser diode.
